(19) United States
(12) Patent Application Publication
(10) Pub. No.: US 2019/0370553 A1
(43) Pub. Date: Dec. 5, 2019

(54) FILTERING OF FALSE POSITIVES USING AN OBJECT SIZE MODEL

(71) Applicant: WIZR LLC, Santa Monica, CA (US)

(72) Inventors: Genquan DUAN, Los Angeles, CA (US); Goran WIBRAN, Cary, NC (US); David CARTER, Marina del Rey, CA (US)

(73) Assignee: WIZR LLC, Santa Monica, CA (US)

(21) Appl. No.: 16/408,258

(22) Filed: May 9, 2019

Related U.S. Application Data
(60) Provisional application No. 62/668,940, filed on May 9, 2018.

(51) Int. Cl. G06K 9/00; G06T 7/60

(52) U.S. Cl. CPC G06K 9/00718; G06T 7/60; G06T 2207/30232; G06K 2009/00738; G06T 2207/10016; G06K 9/00771

(57) ABSTRACT

An object size model filters false positive results in systems using artificial intelligence engines in connection with video cameras and associated video data streams. The system obtains a video data stream and accesses an object size model that has been previously computed for the camera from which the video data stream is obtained. An object is detected in the video stream and a preliminary identification thereof is made. A size range for the identified object is calculated using the object size model. The object size range is compared to an observed size of the object. If observed size of the object is not within the size range for the identified object, the object is deemed to be a false positive.

### BRIEF DESCRIPTION OF THE FIGURES

These and other features, aspects, and advantages of the present disclosure are better understood when the following Detailed Description is read with reference to the accompanying drawings.

FIG. 1 illustrates a block diagram of a system 100 for filtering of false positives using an object size model.

FIG. 2 is a flowchart of an example process for filtering of false positives using an object size model according to some embodiments.

FIG. 3 is a flowchart of an example process for developing an object size model according to some embodiments.

FIG. 4 is a flowchart of an example process for obtaining an object size model according to some embodiments.

FIG. 5 shows an illustrative computational system for performing functionality to facilitate implementation of embodiments described herein.

### DETAILED DESCRIPTION

Systems and methods are disclosed for filtering of false positives using an object size regression model. Systems and methods are also disclosed for developing an object size model and for obtaining an object size model.

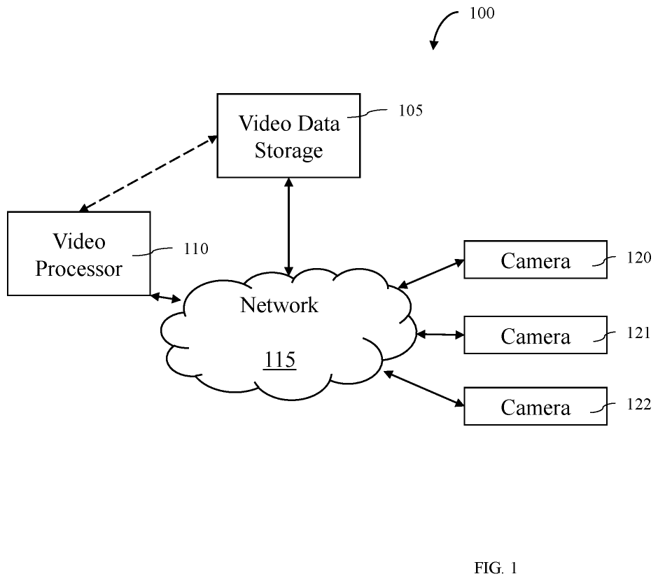

FIG. 1 illustrates a block diagram of a system 100 that may be used in various embodiments. The system 100 may include a plurality of cameras: camera 120, camera 121, and camera 122. While three cameras 120, 121, and 122 are shown, any number of cameras may be included. Alternatively or additionally, in some embodiments, other sources of video such as previously recorded video files or images may be included as described more in detailed below. These cameras 120, 121, and 122 may include any type of video camera such as, for example, a wireless video camera, a black and white video camera, surveillance video camera, portable cameras, battery powered cameras, CCTV cameras, Wi-Fi enabled cameras, smartphones, smart devices, tablets, computers, GoPro cameras, wearable cameras, etc. The cameras 120, 121, and 122 may be positioned anywhere such as, for example, within the same geographic location, in separate geographic locations, positioned to record portions of the same scene, positioned to record different portions of the same scene, etc. In some embodiments, the cameras may be owned and/or operated by different users, organizations, companies, entities, etc.

The cameras 120, 121, and 122 may be coupled with the network 115. The network 115 may, for example, include the Internet, a telephonic network, a wireless telephone network, a 3G network, etc. In some embodiments, the network may include multiple networks, connections, servers, switches, routers, connections, etc. that may enable the transfer of data. In some embodiments, the network 115 may be or may include the Internet. In some embodiments, the network may include one or more LAN, WAN, WLAN, MAN, SAN, PAN, EPN, and/or VPN.

In some embodiments, one more of the cameras 120, 121, and 122 may be coupled with a base station, digital video recorder, or a controller that is then coupled with the network 115.

The system 100 may also include video data storage 105 and/or a video processor 110. In some embodiments, the video data storage 105 and the video processor 110 may be coupled together via a dedicated communication channel that is separate than or part of the network 115. In some embodiments, the video data storage 105 and the video processor 110 may share data via the network 115. In some embodiments, the video data storage 105 and the video processor 110 may be part of the same system or systems.

In some embodiments, the video data storage 105 may include one or more remote or local data storage locations such as, for example, a cloud storage location, a remote storage location, etc.

In some embodiments, the video data storage 105 may store video files recorded by one or more of camera 120, camera 121, and camera 122. In some embodiments, the video files may be stored in any video format such as, for example, mpeg, avi, etc. In some embodiments, video files from the cameras 120, 121, and 122 may be transferred to the video data storage 105 using any data transfer protocol such as, for example, HTTP live streaming (HLS), real time streaming protocol (RTSP), Real Time Messaging Protocol (RTMP), HTTP Dynamic Streaming (HDS), Smooth Streaming, Dynamic Streaming over HTTP, HTML5, Shoutcast, etc.

In some embodiments, the video data storage 105 may store user identified event data reported by one or more individuals. The user identified event data may be used, for example, to train the video processor 110 to capture one or more features of events, to identify one or more events, or to process the video file.

In some embodiments, a video file may be recorded and stored in memory located at a user location prior to being transmitted to the video data storage 105. In some embodiments, a video file may be recorded by the camera 120, 121, and 122 and streamed directly to the video data storage 105.

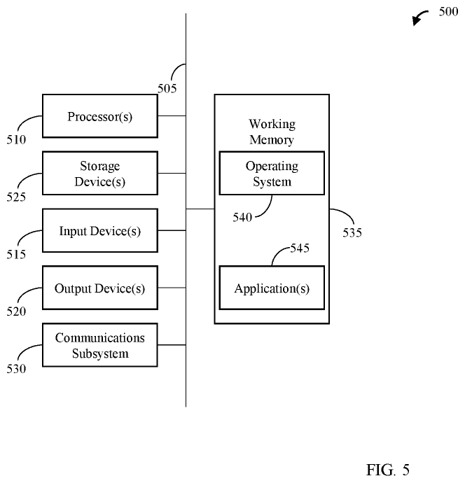

In some embodiments, the video processor 110 may include one or more local and/or remote servers that may be used to perform data processing on videos stored in the video data storage 105. In some embodiments, the video processor 110 may execute one more algorithms on one or more video files stored with the video storage location. In some embodiments, the video processor 110 may execute a plurality of algorithms in parallel on a plurality of video files stored within the video data storage 105. In some embodiments, the video processor 110 may include a plurality of processors (or servers) that each execute one or more algorithms on one or more video files stored in video data storage 105. In some embodiments, the video processor 110 may include one or more of the components of computational system 500 shown in FIG. 5.

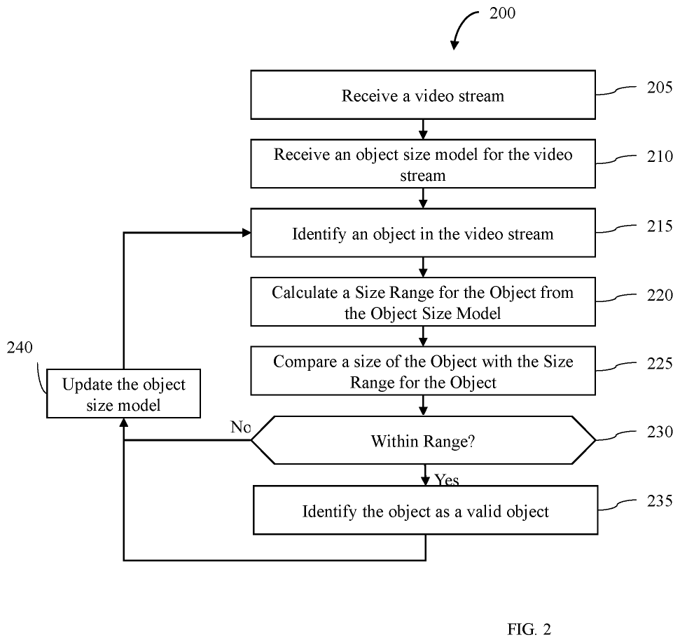

FIG. 2 is a flowchart of an example process 200 for filtering of false positives using an object size model. One or more steps of the process 200 may be implemented, in some embodiments, by one or more components of system 100 of FIG. 1, such as video processor 110. Although illustrated as discrete blocks, various blocks may be divided into additional blocks, combined into fewer blocks, or eliminated, depending on the desired implementation.

Process 200 may begin at block 205. At block 205 the system 200 may receive a video stream. In some embodiments, the video stream may be a video stream from a camera such as, for example, camera 120, camera 121, and/or camera 122. In some embodiments, the video stream may be a video stream stored on a storage device such as the video data storage 105. The video stream, for example, may be received as an mjpeg video stream, h264 video stream, VP8 video stream, MP4, FLV, WebM, ASF, ISMA, flash, HTTP Live Streaming, etc. Various other streaming formats and/or protocols may be used.

In some embodiments, at block 210 the video processor 110 may receive an object size model for the video stream. In some embodiments, the object size model may be a model that has been previously computed for the video stream. In some embodiments, the object size model may be a model that has been previously computed for a camera 120, 121, or 122 that is positioned such that the video streams it generates include a similar scene structure to the video stream received at block 205. In some embodiments, an object size model may be a regression model based on historical images. The object size model may enable a processor, such as the video processor 110, to estimate a size range for an object based on the object's location in the video stream, the type of object, and/or other factors related to the video stream and/or the object.

At block 215 an object may be identified in the video stream. The object may be identified by an object detection algorithm. The identification of the object may include identifying the object as a human, identifying the object as a car, identifying the object as an animal, and/or identifying the object as any particular type of object. Additionally or alternatively, identifying the object may include identifying a particular instance of an object, for example, identifying that the object is a human and identifying who the human is including, for example, determining the human's gender, approximate age, name, and/or other characteristics specific to that particular human. As another example, identifying a car or other vehicle may include identifying the particular make and/or model of the car. In some embodiments, identifying the object may include identifying the location of the object in the video stream and the size of the object. For example, the location of the object may be a position (x, y) where x and y represent pixel locations in a horizontal (x) axis and a vertical (y) axis. In some embodiments, the size of the object may be represented by a height and a width (h, w). Alternatively or additionally, in some embodiments, the size of the object may be represented by a major and minor axis (a1, a2). In some embodiments, the size of the object may be represented by a single value, such as, for example, a height, a width, a radius, or another value.

In some embodiments, at block 220 a size range for the object may be calculated. In some embodiments, the size range for the object may be calculated based on the object size model for the video stream that is received at block 210. In some embodiments, the size range for the object may be calculated based on the identification of the object, including the type of the object, the position of the object, and/or other variables related to the identification of the object. For example, in some embodiments, the object size model may be a function of the object type and the object position. In some embodiments, the function may generate a minimum and maximum size for the object type. For example, the minimum size of the object may be calculated as Sizeₘᵢₙ=f (position, type). In some embodiments, the maximum size of the object may be calculated as Sizeₘₐₓ=f (position, type). In some embodiments, the size of an object may be a width and a height of the object. In some embodiments, the size of an object may be a radius and a height. Alternatively or additionally, other geometric descriptions of objects may be used as the size of an object. Using the object size model, a size range for the object may be calculated. Based on the object size model, the type of the object, and the location of the object in the video stream, the calculated size range for the object may be (Sizeₘᵢₙ, Sizeₘₐₓ). In some embodiments, the size range may be based on a probability model. For example, the size range may be calculated to contain 90%, 95%, 99%, and/or any other percent or fraction of the expected or observed observations of a given object in a given location. In some embodiments, there may not be an object size model that corresponds exactly to the identified object. In these and other embodiments, the video processor 110 may use an object size model for a related type of object.

In these and other embodiments, the minimum and maximum size may be expressed as single variables and/or any number of variables. For example, the minimum size may be a pair of a minimum height and a minimum width (hₘᵢₙ, wₘᵢₙ). The maximum size may be a pair of a maximum height and a maximum width (hₘₐₓ, wₘₐₙ). The minimum and maximum size may then be (hₘᵢₙ, wₘᵢₙ, hₘₐₓ, Wₘₐₓ)=f (x, y, type).

At block 225 the calculated size range of the object may be compared with a size of the object. The size of the object may be part of the identification of the object at block 215.

At block 230 it may be determined whether the size of the object is within the size range for the object. When the size of the object is not within the size range for the object, the object may be deemed to be a false positive. The object may be screened out and identified as not a valid object. The method may proceed to block 240. When the size of the object is within the size range for the object, the object may not be deemed to be a false positive. The method may proceed to block 235.

At block 235 the object may be identified as a valid object. Because the size of the object is within the size range calculated from the object size model (“Yes” at block 230), the system 100 may identify the object as a valid object. In some embodiments, identifying the object as a valid object may result in interaction with rules based on the object. For example, in some embodiments, a user may be notified if an object is present in a video stream. When the object is identified in the video stream and the size of the object is within the size range for the object, a user may be notified that the object is present in the video stream. When the object is identified in the video stream and the size of the object is not within the size range for the object, a user may not be notified that the object is present in the video stream. In this manner, in some embodiments, the method 200 may filter false positives and may prevent spurious notification of a user.

In some embodiments, when the object is identified as a valid object, a user may be interested in seeing additional information for the object. In some embodiments, the system 100 may include one or more web servers that may host a website where users can interact with video streams stored in the video data storage 105, select video streams to view, select video streams to monitor using embodiments described in this document, assign or modify segments, search identified valid objects and identified not valid objects, modify the object size model for the video stream, modify the particular objects of interest for the camera and/or for the video stream, select cameras from which to create segments and correlate rule conditions and responses, etc. In some embodiments, the website may allow a user to select a camera that the user wishes to monitor. For example, the user may enter the IP address of the camera, a user name, and/or a password. Once a camera 120, 121, or 122 has been identified, for example, the website may allow the user to view video and/or images from the camera 120, 121, or 122 within a frame or page being presented by the website. As another example, the website may store the video stream from the camera 120, 121, or 122 in the video data storage 105 and/or the video processor 110 may begin processing the video from the camera 120, 121, or 122 to identify objects, calculate size ranges, compare size ranges with sizes of objects, etc. The method may proceed to block 240.

In block 240, the object size model may be updated based on the classification of the object as either a valid object or not as a valid object. The method may return to block 215 and identify another object in the video stream. In some embodiments, the object size model obtained in block 210 may be updated based on the video stream obtained in block 205. In these and other embodiments, although the object size model obtained in block 210 may be obtained from another device, system, or camera, the method 200 may update the object size model based on a camera associated with the video stream obtained in block 205 or based on other features or characteristics related to a particular implementation of the method 200.

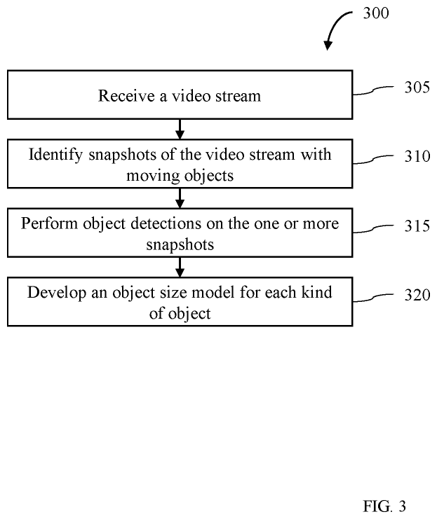

FIG. 3 is a flowchart of an example process 300 for developing an object size model. One or more steps of the process 300 may be implemented, in some embodiments, by one or more components of system 100 of FIG. 1, such as video processor 110. Although illustrated as discrete blocks, various blocks may be divided into additional blocks, combined into fewer blocks, or eliminated, depending on the desired implementation.

Process 300 may begin at block 305. At block 305 the system 300 may receive a video stream. In some embodiments, the video stream may be a video stream from a camera such as, for example, camera 120, camera 121, and/or camera 122. In some embodiments, the video stream may be a video stream stored on a storage device such as the video data storage 105. The video stream, for example, may be received as an mj peg video stream, h264 video stream, VP8 video stream, MP4, FLV, WebM, ASF, ISMA, flash, HTTP Live Streaming, etc. Various other streaming formats and/or protocols may be used.

In some embodiments, at block 310 the video processor 110 may identify one or more snapshots of the video stream that include moving objects. For example, snapshots of the video stream may include images in which a human is moving or a vehicle is moving. Alternatively or additionally, the snapshots may include images in which an animal enters the image or leaves the image. In these and other embodiments, the video processor may determine that an object is moving but may not identify the type of object.

At block 315 object detections may be performed on the one or more snapshots of the video stream. In these and other embodiments, the object detections may include identifying a type of the object. For example, the identification of the object may include identifying the object as a human, identifying the object as a car, identifying the object as an animal, and/or identifying the object as any particular type of object. As discussed above with reference to FIG.1, identifying the object may include identifying a particular instance of an object. As another example, identifying a car or other vehicle may include identifying the particular make and/or model of the car. In some embodiments, identifying the object may include identifying the location of the object in the video stream and the size of the object. For example, the location of the object may be a position (x, y) where x and y represent pixel locations in a horizontal (x) axis and a vertical (y) axis. In some embodiments, the size of the object may be represented by a height and a width (h, w). Alternatively or additionally, in some embodiments, the size of the object may be represented by a major and minor axis (a1, a2). In some embodiments, the size of the object may be represented by a single value, such as, for example, a height, a width, a radius, or another value. The objects may be identified or detected by an object detection algorithm.

In some embodiments, at block 320 an object size model may be developed for each kind of object. Alternatively or additionally, in some embodiments, a single object size model may be developed for every kind of object and may include the kind of object as an input. In some embodiments, the object size model may be a function that may generate a size for an object as a function of the object's type and location within the image. In some embodiments, the object size model may be generated based on a regression of the objects detected in the one or more snapshots of the video stream. For example, in some embodiments, the object size model may be calculated using a least-squares regression of the detected object sizes for a certain kind of object on the location of the object. For example, in some embodiments, the object size model of human objects may be calculated using least squares regression on the height of the human objects on the coordinate position (x, y) of the human objects. For example, in some embodiments, the object size model may be a function of the object type and the object position. In some embodiments, the parameters of the object size model may be determined using linear regression of the position of the objects. Alternatively or additionally, other regressions could be performed to generate an object size model for the particular object type and video stream. In some embodiments, the object size model may generate a minimum and maximum size for the object type. For example, the minimum size of the object may be calculated as Sizeₘᵢₙ=f (position, type). In some embodiments, the maximum size of the object may be calculated as Sizeₘₐₓ=f (position, type). In some embodiments, the object size model may be based on a probability model. For example, the object size model may generate a size range calculated to contain 90%, 95%, 99%, and/or any other percent or fraction of the expected or observed observations of a given object in a given location.

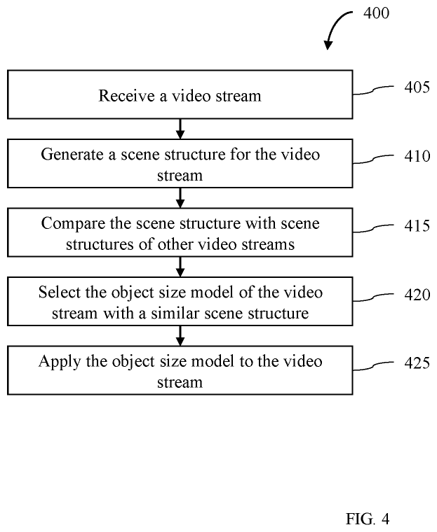

FIG. 4 is a flowchart of an example process 400 for obtaining an object size model. One or more steps of the process 400 may be implemented, in some embodiments, by one or more components of system 100 of FIG. 1, such as video processor 110. Although illustrated as discrete blocks, various blocks may be divided into additional blocks, combined into fewer blocks, or eliminated, depending on the desired implementation.

Process 400 may begin at block 405. At block 405 the system 400 may receive a video stream. In some embodiments, the video stream may be a video stream from a camera such as, for example, camera 120, camera 121, and/or camera 122. In some embodiments, the video stream may be a video stream stored on a storage device such as the video data storage 105. The video stream, for example, may be received as an mjpeg video stream, h264 video stream, VP8 video stream, MP4, FLV, WebM, ASF, ISMA, flash, HTTP Live Streaming, etc. Various other streaming formats and/or protocols may be used.

In some embodiments, at block 410 the video processor 110 may generate a scene structure for the video stream. In some embodiments, generating the scene structure may include parsing the scene for the video stream into different components. In some embodiments, the different components may include the sky, buildings, roads, and trees. In these and other embodiments, the scene structure may include the relative structure of different components of the video stream. In these and other embodiments, generating the scene structure may include identifying a video stream angle, a video stream height, and a video stream depth.

At block 415 the scene structure generated at block 410 may be compared with scene structures of other video streams. In some embodiments, there may be a database of video stream scene structures. In these and other embodiments, the scene structure generated at block 410 may be compared with other scene structures by comparing the relative structure of different components of each video stream. For example, in some embodiments, the scene structure generated at block 410 may include a certain video stream angle. A scene structure of a different video stream may include a similar video stream angle. Alternatively or additionally, a scene structure of a different video stream may include scene components, such as the sky, buildings, roads, and/or trees in approximately the same location or at approximately the same angles as the scene structure generated at block 410.

In some embodiments, at block 420 an object size model of the video stream with a similar scene structure may be selected. In some embodiments, the video processor 110 may identify a video stream that has a similar scene structure to the scene structure generated at block 410 based on the comparison at block 415. An object size model for the identified video stream may be selected. In some embodiments, the video processor 110 may identify a video stream that has a most similar scene structure. In these and other embodiments, the similarity of the scene structures may be determined based on the components of the scene structures, based on the angle of the video streams, based on the height of the video streams, and/or based on other factors related to the video streams.

At block 425 the selected object size model may be applied to the video stream. In these and other embodiments, the object size model may be updated and refined as time progresses and as additional video stream is received.

The computational system 500 (or processing unit) illustrated in FIG. 5 can be used to perform and/or control operation of any of the embodiments described herein. For example, the computational system 500 can be used alone or in conjunction with other components. As another example, the computational system 500 can be used to perform any calculation, solve any equation, perform any identification, and/or make any determination described here.

The computational system 500 may include any or all of the hardware elements shown in the figure and described herein. The computational system 500 may include hardware elements that can be electrically coupled via a bus 505 (or may otherwise be in communication, as appropriate). The hardware elements can include one or more processors 510, including, without limitation, one or more general-purpose processors and/or one or more special-purpose processors (such as digital signal processing chips, graphics acceleration chips, and/or the like); one or more input devices 515, which can include, without limitation, a mouse, a keyboard, and/or the like; and one or more output devices 520, which can include, without limitation, a display device, a printer, and/or the like.

The computational system 500 may further include (and/or be in communication with) one or more storage devices 525, which can include, without limitation, local and/or network-accessible storage and/or can include, without limitation, a disk drive, a drive array, an optical storage device, a solid-state storage device, such as random access memory (“RAM”) and/or read-only memory (“ROM”), which can be programmable, flash-updateable, and/or the like. The computational system 500 might also include a communications subsystem 540, which can include, without limitation, a modem, a network card (wireless or wired), an infrared communication device, a wireless communication device, and/or chipset (such as a Bluetooth® device, a 802.6 device, a Wi-Fi device, a WiMAX device, cellular communication facilities, etc.), and/or the like. The communications subsystem 540 may permit data to be exchanged with a network (such as the network described below, to name one example) and/or any other devices described herein. In many embodiments, the computational system 500 will further include a working memory 535, which can include a RAM or ROM device, as described above.

The computational system 500 also can include software elements, shown as being currently located within the working memory 535, including an operating system 540 and/or other code, such as one or more application programs 545, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 525 described above.

In some cases, the storage medium might be incorporated within the computational system 500 or in communication with the computational system 500. In other embodiments, the storage medium might be separate from the computational system 500 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 500 and/or might take the form of source and/or installable code, which, upon compilation and/or installation on the computational system 500 (e.g., using any of a variety of generally available compilers, installation programs, compression/decompression utilities, etc.), then takes the form of executable code.

The term “substantially” means within 5% or 10% of the value referred to or within manufacturing tolerances.

Various embodiments are disclosed. The various embodiments may be partially or completely combined to produce other embodiments.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for-purposes of example rather than limitation, and does not preclude inclusion of such modifications, variations, and/or additions to the present subject matter as would be readily apparent to one of ordinary skill in the art.

1.-3. (canceled)

4. A method for filtering false positives using an object size model, the method comprising:
receiving a video stream;
accessing an object size model for the video stream;
identifying an object in the video stream;
calculating a size range for the object from the object size model;
comparing a size of the object with the size range for the object; and
in response to the size of the object not being within the size range for the object, identifying the object as not a valid object.

5. The method of claim 4, wherein receiving the video stream comprises receiving the video stream from a security camera.

6. The method of claim 5, further comprising:
determining that an event preliminarily detected by the security camera is a false positive based on identifying the object as not a valid object.

7. The method of claim 6, further comprising:
providing information to a user of the security camera, constituting a report that the false positive has been detected.

8. The method of claim 6, further comprising:
determining that the false positive will not be reported to a user of the security camera.

9. The method of claim 4, further comprising:
updating the object size model based on the video stream and based on identifying the object as not a valid object.
